(19) United States
(12) Patent Application Publication
(10) Pub. No.: US 2016/0012373 A1
(43) Pub. Date: Jan. 14, 2016

(54) AUTOMATICALLY GENERATING A MULTIMEDIA PRESENTATION OF EMPLOYEE PERFORMANCE DATA

(71) Applicants: RAJARAM VISWANATHAN, Bangalore (IN); SHAROSH RAJASEKHER, Bangalore (IN); NISCHAL RAO, Bangalore (IN)

(72) Inventors: RAJARAM VISWANATHAN, Bangalore (IN); SHAROSH RAJASEKHER, Bangalore (IN); NISCHAL RAO, Bangalore (IN)

(21) Appl. No.: 14/327,567

(22) Filed: Jul. 10, 2014

(51) Int. Cl. G06Q 10/06; G06F 17/30; G06F 3/0484

(52) U.S. Cl. CPC G06Q 10/06398; G06F 3/0484; G06F 17/30058

(57) ABSTRACT

Various embodiments of systems and methods for representing employee performance in a multimedia presentation are described herein. The method involves receiving a set of inputs from a user relating to one or more tasks involving the user, at a various point in time. In response to a request for accessing a performance review form, the received set of inputs are encoded into graphical elements and a multimedia presentation is generated using the graphical elements and rendered in response to the received request. Further, the method involves receiving self-assessment data from the user based on viewing the multimedia presentation and automatically transferring the self-assessment data to corresponding fields of a performance review form.

### FIELD

This application relates generally to performance management systems and more specifically to a technology for generating a multimedia representation of employees' performance.

### BACKGROUND

Performance management systems are employed “to manage and align” all of an organization's resources in order to achieve highest possible performance. The manner in which performance is managed in an organization determines to a large extent the success or failure of the organization. One of the effective tools used in managing the performance of an employee is performance appraisal (or performance review). A performance appraisal is a systematic and periodic process that assesses an individual employee's job performance and productivity in relation to certain pre-established criteria and organizational objectives. Performance appraisal also serves as a platform for the employee to communicate and highlight his achievements to the management. Performance appraisal usually involves documentation of an individual's accomplishments against a set of goals to aid in evaluating and rating the employee's performance at the end of a performance cycle. Typically, the performance cycle spans a year, half-year, or a quarter year. However, the task of documenting the individual's accomplishments at the end of a performance cycle, for example, at the end of a year could be quite arduous. Not only is the employee required to recollect such information from memory but also verbosely fill in a form for the manager's review. Sometimes, employees may fail to recollect certain significant achievements or contributions related to their goals and competencies.

It may be equally challenging for managers to review each of their direct reports' performance appraisal forms, as they may have to read through long and wordy descriptions of the employees' accomplishments. Often, this results in the managers failing to take note of key contributions by the employees and providing a justified rating during the performance review.

### SUMMARY

Various embodiments of systems and methods for representing employee performance in a multimedia presentation are described herein. In an aspect, the method involves receiving a first set of inputs from a user relating to a first task involving the user, at a first point in time. At least one of the first set of inputs is a selection of one or more goal types. Further, the method involves receiving a second set of inputs from the user relating to a second task involving the user, at a second point in time. The first set of inputs and the second set of inputs are composed of strings of characters. In another aspect, the method involves encoding the first set of inputs and the second set of inputs into graphical elements. In yet another aspect, a multimedia presentation is generated using the graphical elements and rendered in response to a request received at a third point in time. The first and second point in time belong to a performance cycle, whereas the third point in time belongs to an assessment period. Further, receiving self-assessment data from the user based on viewing the multimedia presentation is involved. In an aspect, the self-assessment data is received under one or more goal types. In another aspect, the received self-assessment data is automatically transferred to corresponding fields of a performance review form based on the one or more goal types.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating elements of an exemplary system consistent with implementations of the current subject matter, according to one embodiment.

FIG. 2 is a flow diagram of a process of representing employee performance in a multimedia presentation, according to one embodiment.

FIG. 3 illustrates a performance management dashboard, in accordance with an embodiment.

FIG. 4 illustrates a performance management dashboard, in accordance with an embodiment.

FIG. 5 illustrates a performance management dashboard, in accordance with another embodiment.

FIG. 6 illustrates a multimedia presentation, in accordance with another embodiment.

FIG. 7 illustrates a performance management dashboard for receiving self-assessment data, in accordance with an embodiment.

FIG, 8 illustrates a performance review form, in accordance with another embodiment.

FIG. 9 is a block diagram of an exemplary computer system according to one embodiment.

### DETAILED DESCRIPTION

Embodiments of techniques for representing employee performance in a multimedia presentation are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

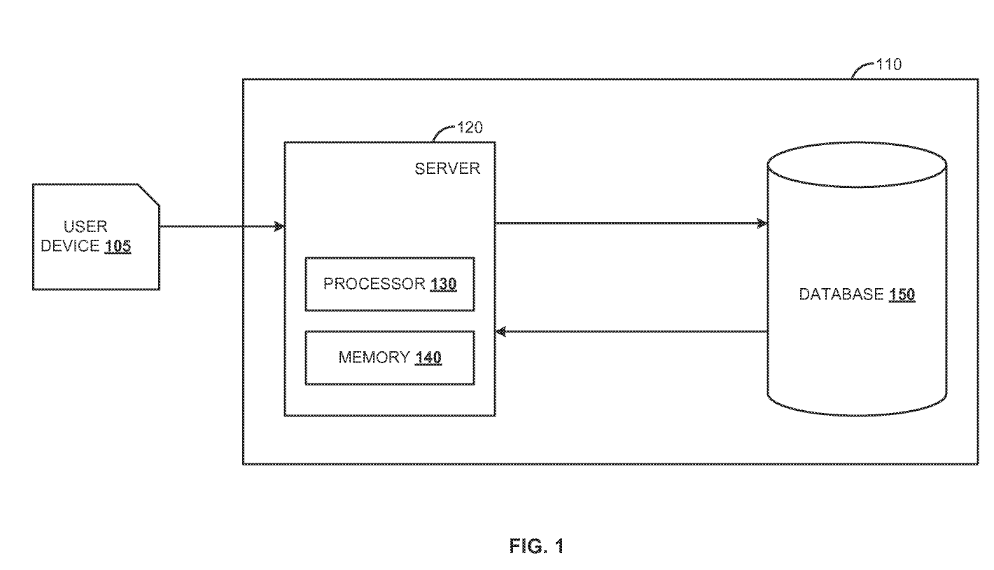

FIG. 1 is a high level block diagram illustrating a system environment, in accordance with an embodiment. The system environment comprises user device 105 and performance management system 110. In some embodiments, the performance management system 110 is implemented as a single server, while in other embodiments it is implemented as a distributed system of multiple servers. For ease of explanation, the performance management system 110 is described below as being implemented on a single server system. An embodiment of the performance management system 110 shown in FIG. 1 includes server 120, and database 150. The server 120 includes processor 130 and memory 140 having instructions for converting the performance log of an employee into a multimedia presentation. The performance management system 110 is communicatively coupled to the user device 105.

A user interacts with the performance management system 110 via the user device 105, which may be any suitable device that is capable of connecting to the performance management system 110. Examples of the user device 105 include computer, laptop, smartphone, personal digital assistant, notepad, notebook, tablet, etc. The user device 105 may be accessed by an employee or management personnel, hereinafter referred to simply as a ‘user’, having sufficient authority.

In an embodiment, the server 120 receives a set of performance data via a user interface of a performance management tool. The set of data includes information relating to a task such as a project, a role, a function, an assignment, etc., undertaken by an employee during a performance cycle. The server may receive such information from time to time, or as and when an employee undertakes or completes a task during the performance cycle. In an aspect, the received set of data may also include an identity of a peer or a superior and a request for feedback from the identified peer or superior. In another aspect, the received set of data includes a selection of one or more types of goals or competencies that may be relevant to the task that is undertaken or completed by the employee.

For example, the server receives data relating to a project undertaken or attended by the employee. The employee may provide such information as a title of the project, project description, duration of the project, details of other members involved in the project, request for feedback, goals or competencies achieved by way of doing this project, etc., via an interface provided by the performance management tool. The received information may be in textual form composed of a combination of alphabets, numerical digits, and punctuation marks.

The processor 130 may generate a performance log of the tasks undertaken or completed by the employee along with any feedback received from peers, and stores it in the database 150. Further, the server receives a request from the employee via the user device 105 to view the performance log. In an aspect, the employee may request for viewing the performance log during an assessment period which follows the performance cycle.

In response to the request, the processor 130 accesses the performance log of the employee from the database 150. Further, the processor 130 generates one or more graphical elements to visually represent the textual content of the data in the performance log, In an aspect, the graphical elements may be generated using HyperTextMarkup Language (HTML), JavaScript, and Cascading Style Sheets (CSS). The processor 130 may generate a multimedia presentation using the graphical elements, and may render the multimedia presentation on the display of the user device for viewing. The performance management tool may provide an interface for receiving feedback and/or rating for each task recorded in the multimedia presentation. The interface includes one Of more fields for each of the goal types or competencies selected by the employee (while providing the performance data for a particular task). The employee may provide his/her assessment of his/her performance in each task under each of the associated goal types.

The processor 130 may access a performance review form at the database 150, and automatically transfer the self-assessment data under each goal type directly into the corresponding fields in the performance review form. The processor 130 may store the performance review form along with the multimedia presentation in the database 150. In an aspect, the interface provides an option to preview the self-assessment data provided by the employee before transferring the self-assessment data to the performance review form.

The processor 130 may receive a request from an appraiser to view the performance review form for an employee. In response to the request, the processor 130 accesses the multimedia presentation and the performance review form for the employee at the database 150, and may automatically play the multimedia presentation on a user device associated with the appraiser.

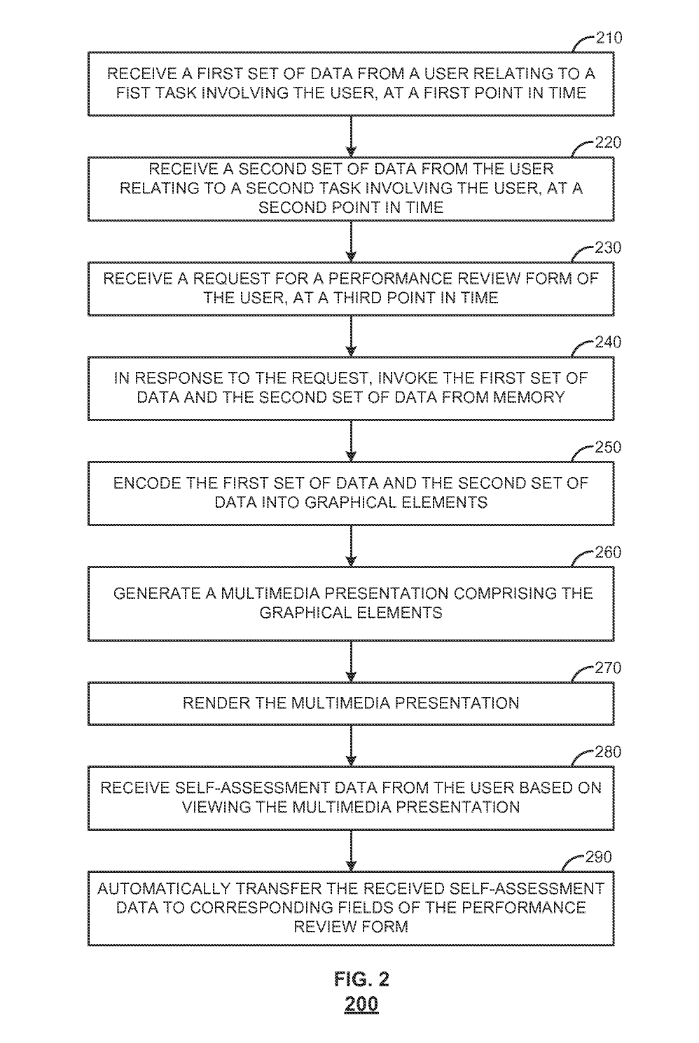

FIG. 2 illustrates a flow diagram of process 200 of representing employee performance in a multimedia presentation. Portions of process 200, as shown in FIG. 2, are performed at a system (e.g., performance management system 110) having one or more processors and non-transitory memory, which stores one or more instructions to be executed by the one or more processors of the system. In an aspect, an employee may create a new performance log by accessing a dashboard of a performance management tool hosted by the performance management system. Alternatively, a manager of the employee may initiate the performance logging task by creating a log of a project in the performance management portal and adding a set of employees as participants in the project. The set of employees may then receive a notification in their respective performance management portal. The respective employee may provide detailed description relating to his/her individual contribution to the project by accessing a link provided in the notification. By accessing the link, the employee may access the dashboard of the performance management tool. In an aspect, the dashboard may provide fields for Title, Start Date, End Date, Role Played, Associated Goals, Colleagues, etc., where the employee can enter descriptive data relating to the task undertaken or completed by the employee. The process 200 involves receiving a first set of data relating to a first task from an employee at a first point in time, at 210. The term “first point in time” as used herein refers to a particular point in time during the performance cycle. In an aspect, the first set of data includes information relating to a particular task undertaken by the employee. For example, the first set of data may relate to a pilot program that the employee is working on and include information such as the name of the program, duration of the program, colleagues in the program, goals achieved by way of working on this program, request for feedback, achievements, awards, etc.

Further, the process involves receiving a second set of data relating to a second task from the employee at a second point in time, at 220. The term “second point in time” as used herein refers to a point in time, subsequent to the first point in time, during the performance cycle. The second set of data includes information relating to another task undertaken by the employee. The first and second set of data is primarily in textual form and may include numerical digits and punctuation marks. The first set of data and the second set of data may be stored in a performance log for the employee in a repository e.g., by the performance management system.

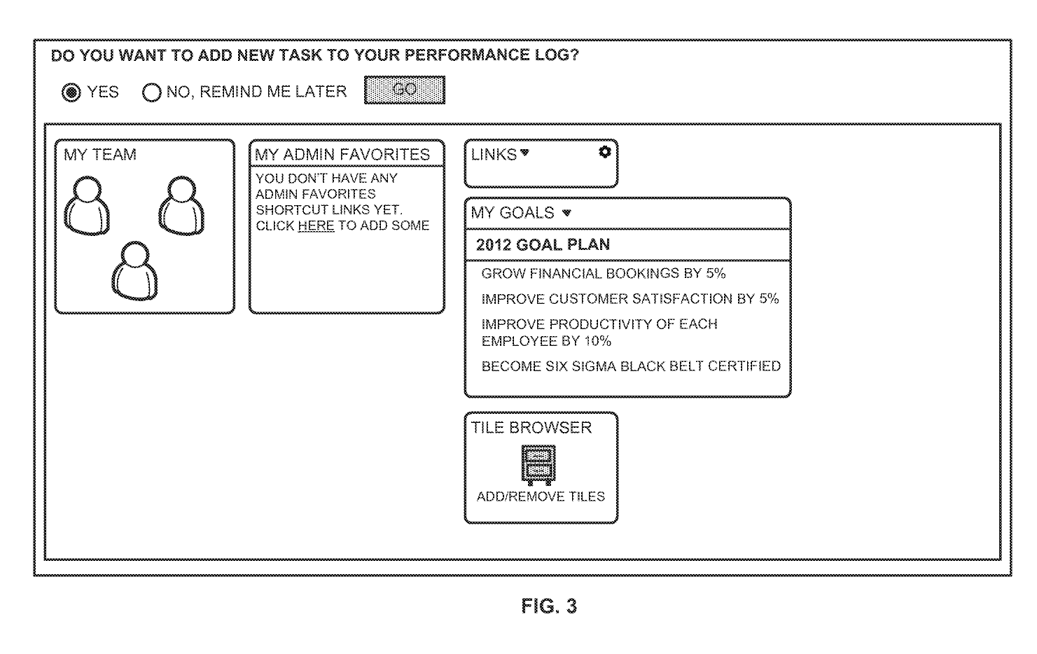

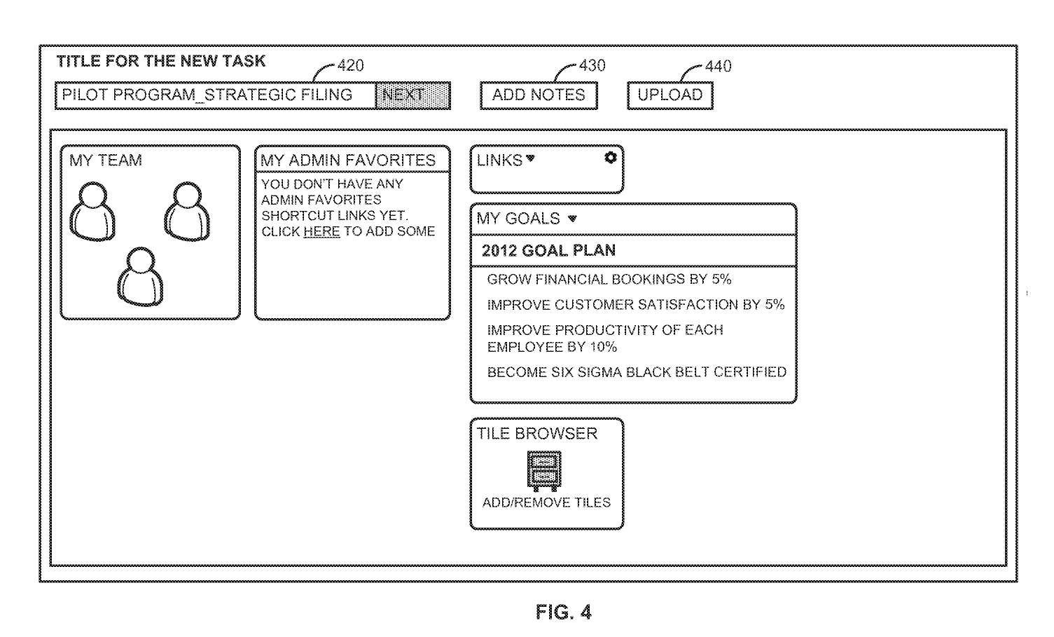

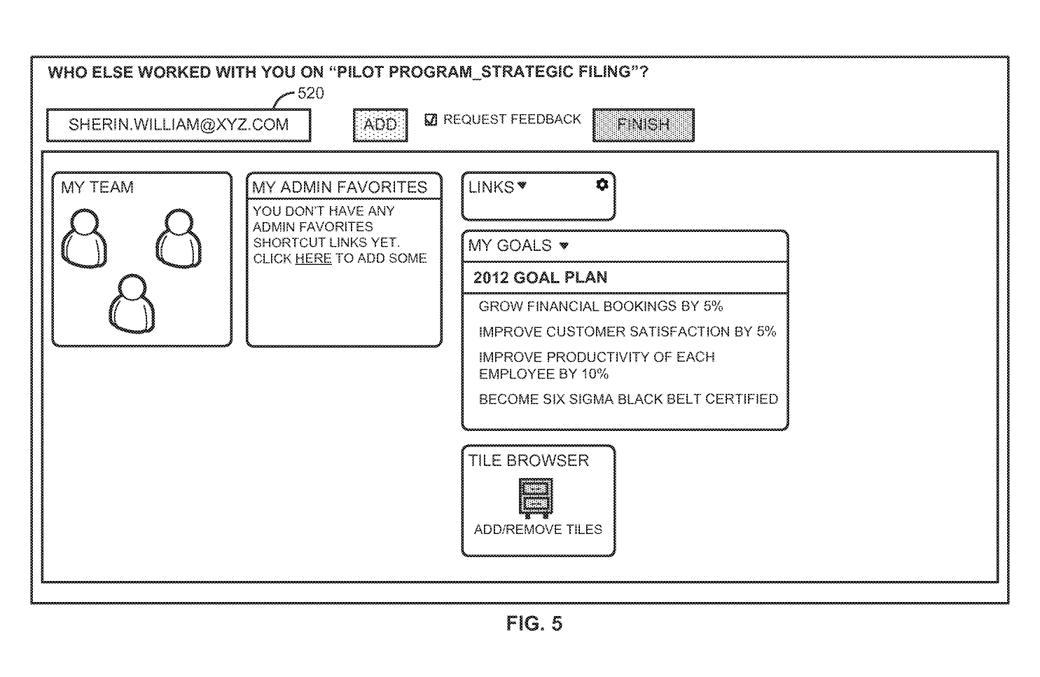

In an embodiment, as shown in FIG. 3, the employee may access the dashboard and select an option to add a new task to his/her performance log. In response to receiving the request, a set of fields for receiving descriptive data relating to the new task is provided on the interface of the dashboard. As shown in FIGS. 4-5, the fields 420, 520 are presented to the user in a sequence, Alternatively, the fields may be provided simultaneously in a single interface. Further, the dashboard may include an option 430 (FIG. 4) to add notes in case the employee wants to enter additional descriptive data along with, e.g., the duration of the task. For example, the employee may want to mention in the performance log that the task was completed within a record time, much ahead of the target completion data. In addition, the dashboard may include an option 440 (FIG. 4) to upload media content such as video, image, or audio file. For example, the employee may want to add a demo of a project, or an audio clip of feedback received over a call.

Referring back to FIG. 2, at 230, the process involves receiving a request for generating and/or viewing a performance review form of the employee at a third point in lime. In an aspect, the request is received from the employee for self-assessment during an assessment period. The employee self-assessment may be performed at the end of a performance cycle, or intermittently throughout the performance cycle. In response to receiving the request, the performance management tool, accesses the first set of data and the second set of data (performance log) for the employee from the repository, at 240, and encodes the content of the performance log into graphical elements, at 250. In an example, the first set of data relates to a first project and the second set of data relates to a second project. The first and second set of data may include information such as title of the project, project description, role played by the employee, duration of the project, other participants in the project, feedback from peers, achievements, and any other additional notes. The information may be converted into graphical elements including but not limited to image, visual cue, histogram, plot, graph, chart, etc. For example, the feedback received from peers may be represented by a photo of the respective peer and a quote of the peer's feedback. In an aspect, the photos of the peers may be extracted from the profile information corresponding to each peer. Alternatively, a symbol representing a person may be used to represent the peer. In another example, the duration of each task performed by an employee may be shown in a pie chart, with the arc length of each sector representing the length of time taken for each task. In an aspect, the graphical elements may be selected according to a template. In another aspect, the graphical elements may be selected according to a set of rules defined during design time.

Further, the process involves, generating a multimedia presentation comprising the graphical elements, at 260, and rendering the multimedia presentation on a user interface, at 270. In an aspect, during rendering, the graphical elements may be presented using animation effects or graphics. The term “multimedia” as used herein refers to content that uses a combination of different media forms. For example, multimedia includes a combination of text, audio, still images, animation, and/or video.

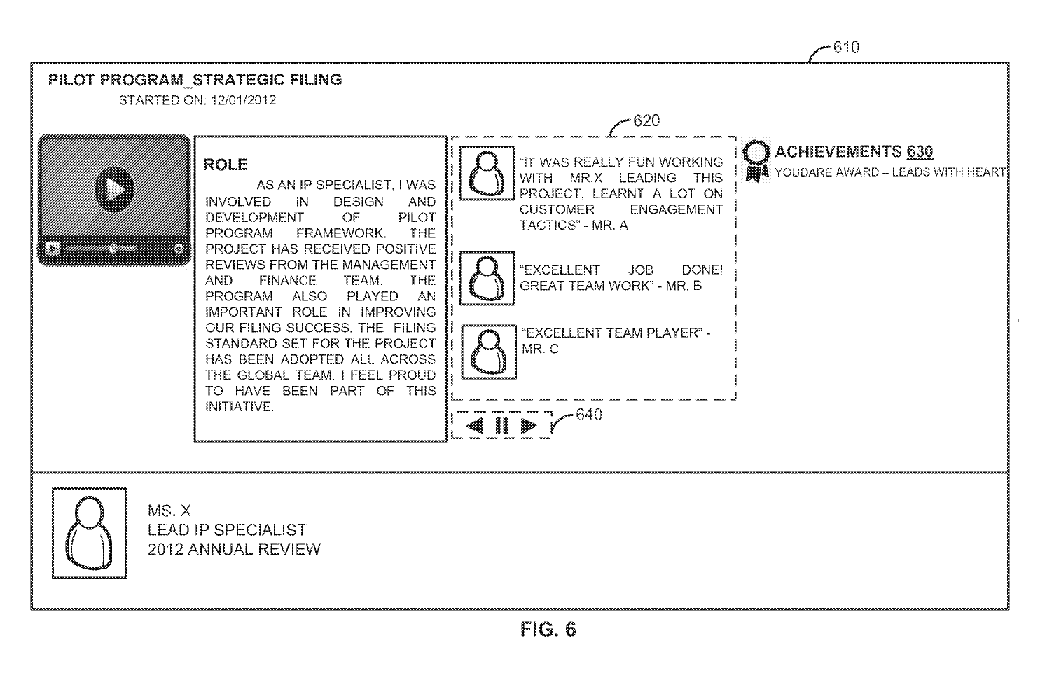

In an embodiment, as shown in FIG. 6, the multimedia presentation 610 includes data relating to the tasks added to the performance log and any feedback 620 received from the peers to whom a request for feedback was sent. Further, the presentation may include one Of more achievements 630 by the employee. In an aspect, the performance data may be represented in the multimedia presentation in a chronological order. For example, the tasks that are recorded in the performance log may be ordered according to the start date of the tasks. In another aspect, the tasks in the performance log may be represented in the multimedia presentation according to an order of significance. For example, projects may be assigned a significance score based on the number of feedback requests sent or received. The performance data may be presented along with background images, photos, graphical icons, video, music, and other graphical representations. The content of the multimedia presentation may progress without navigational control and may be played using a media player. The viewer may however, control the playing of the presentation by pausing, forwarding, rewinding, etc., using controls 640.

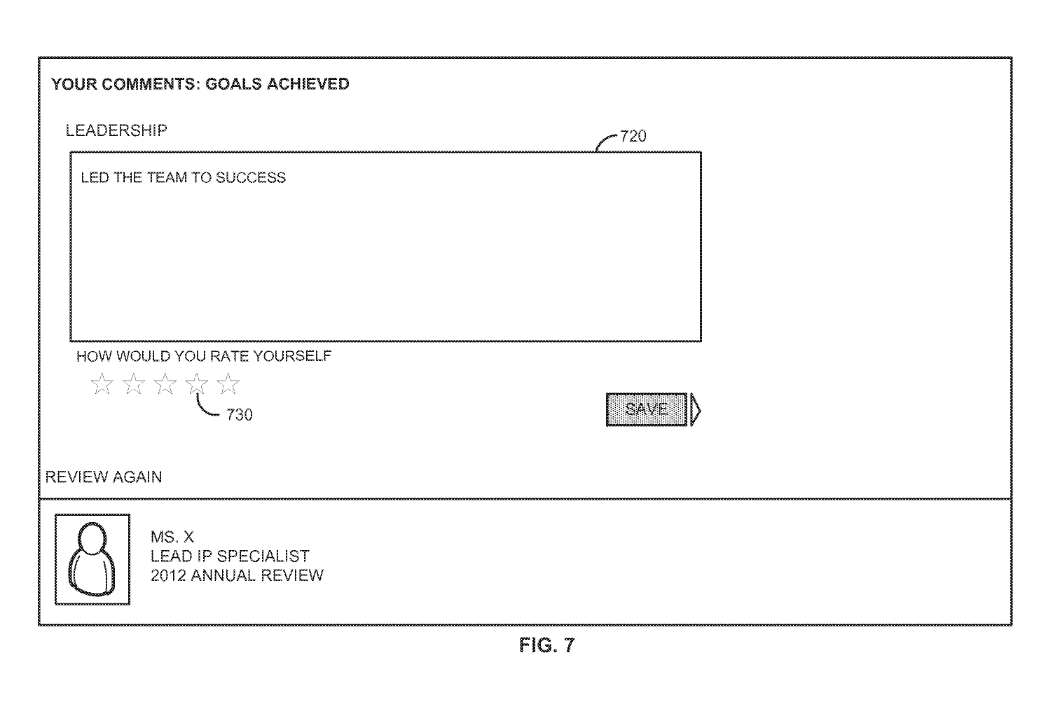

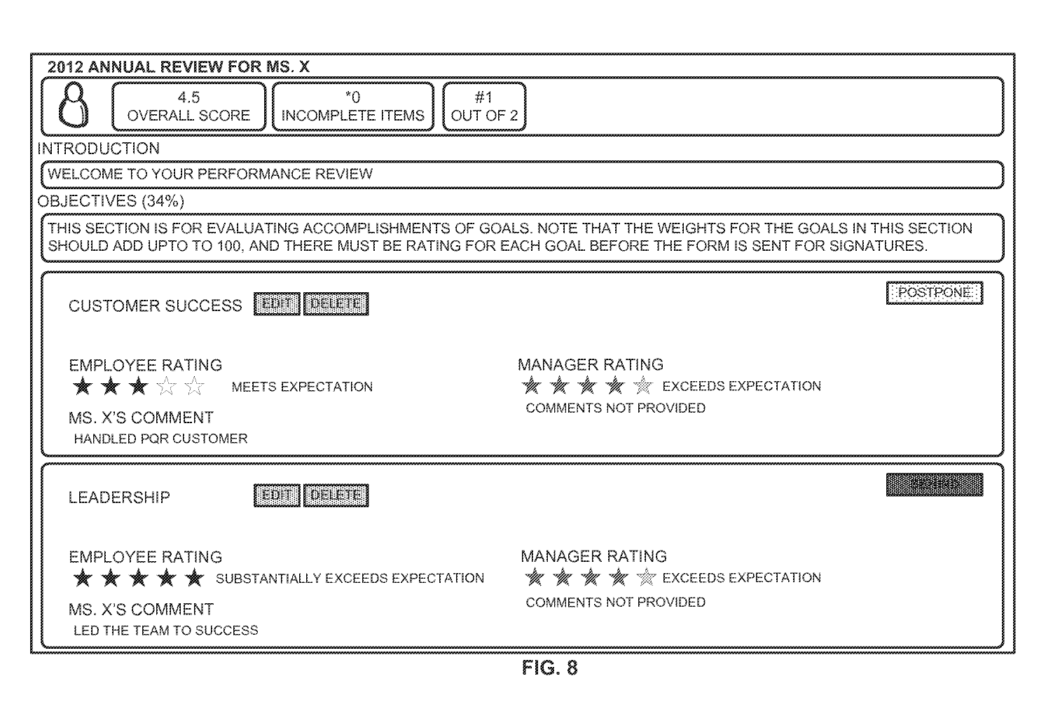

Referring back to FIG. 2, the process 200 further involves receiving self-assessment data from the employee based on the employee viewing the multimedia presentation, at 280. The term “self-assessment data” as used herein refers to feedback provided by the employee on his/her own performance based on viewing the multimedia presentation rendered at 270. In an aspect, the self-assessment data is received for each task, and for each goal type associated with each task. In an example, as shown in FIG. 7, the interface for receiving self-assessment (employee review) data from the employee is rendered subsequent to playing the multimedia presentation on the user device. The interface includes fields marked with a particular goal type and a widget for selecting a rating for the particular goal type. In the given example, the employee may enter his comments in the field 720 and select rating at 730. Upon saving the data, the interface provides a field for next goal, if any, until all the goals associated with that particular task have been rated and reviewed by the employee.

Further, at 290, the received self-assessment data is automatically transferred to corresponding fields of a performance review form. In an aspect, the self-assessment data may also be appended to the performance log of the employee and represented as graphical elements in the multimedia presentation. FIG. 8 shows an exemplary review form, according to one embodiment. As illustrated, the performance review form includes the self-assessment data provided by the user via the interface rendered subsequent to rendering the multimedia presentation.

In an embodiment, an appraiser such as a manager of the employee may provide request to view the performance review form of an employee during an assessment period, for evaluating the performance of the employee, in response to the request, the performance management tool, accesses the multimedia presentation for the employee from the database and automatically plays the multimedia presentation on the user device associated with the appraiser. Subsequent to rendering the presentation, the tool may render the performance review form so the appraiser may provide evaluation of the employee's performance based on the presentation showing the performance of the employee.

Some embodiments may include the above-described processes being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

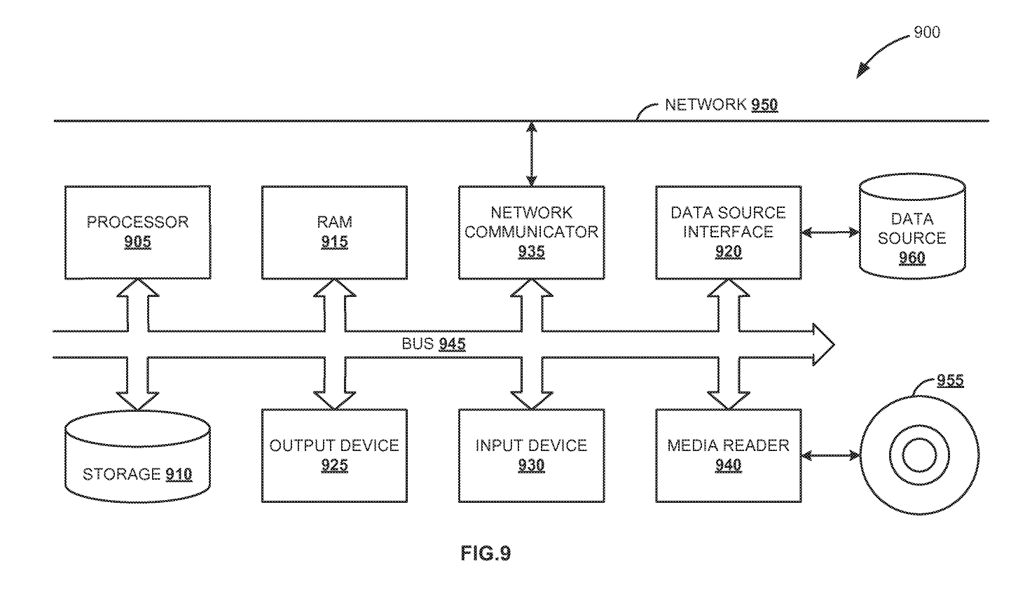

FIG. 9 is a block diagram of an exemplary computer system 900. The computer system 900 includes a processor 905 that executes software instructions or code stored on a computer readable storage medium 955 to perform the above-illustrated processes. The processor 905 can include a plurality of cores. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. According to some embodiments, such as some in-memory computing system embodiments, the RAM 915 can have sufficient storage capacity to store much of the data required for processing in the RAM 915 instead of in the storage 910. In some embodiments, all of the data required for processing may be stored in the RAM 915. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance, The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. in other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer-implemented method of representing employee performance in a multimedia form, the method comprising:
receiving, via a user interface of a computer, a first set of data from a user relating to a first task involving the user, at a first point in time, wherein the first set of data is composed of strings of characters, further wherein at least one of the first set of data is a selection of one or more goal types;
receiving a second set of data from the user relating to a second task involving the user, at a second point in time, wherein the second set of data is composed of strings of characters;
receiving, by the computer, a request to perform a performance review for the user, at a third point in time;
in response to the request, invoking the first set of data and the second set of data from memory;
encoding, by the computer, the first set of data and the second set of data into graphical elements;
generating, by the computer, a multimedia presentation comprising the graphical elements; and
rendering the multimedia presentation.

2. The method of claim 1, wherein the first point in time and the second point in time belong to a performance cycle and the third point in time belongs to an assessment period.

3. The method of claim 1 further comprising receiving self-assessment data from the user based on viewing the multimedia presentation, wherein the self-assessment data is received under at least one of the one or more goal types.

4. The method of claim 3, further comprising automatically transferring the received self-assessment data to corresponding fields of a performance review form.

5. The method of claim 1, wherein at least one of the first set of data is a request for feedback from one or more other users.

6. The method of claim 5, wherein encoding includes encoding feedback received from the one or more other users.

7. A non-transitory computer-readable storage medium storing instructions therein, which when executed by a programmable processor, causes the programmable processor to:
receive, via a user interface, a first set of inputs from a user relating to a first task involving the user, at a first point in time, wherein the first set of inputs is composed of strings of characters, further wherein at least one of the first set of inputs is a selection of one or more goal types;
receive a second set of inputs from the user relating to a second task involving the user, at a second point in time, wherein the second set of inputs is composed of strings of characters;
encode the first set of inputs and the second set of inputs into graphical elements;
generate a multimedia presentation comprising the graphical elements;
receive a request to access a performance review form for the user, at a third point in time;
render the multimedia presentation in response to the received request;
receive self-assessment data from the user based on viewing the multimedia presentation, wherein the self-assessment data is received under al least one of the one or more goal types;
automatically transfer the received self-assessment data to corresponding fields of the performance review form based on the one or more goal types; and
render the performance review form.

8. The article of claim 7, wherein the first point in time and the second point in time belong to a performance cycle and the third point in time belongs to an assessment period.

9. The article of claim 7, wherein at least one of the first set of data is a request for feedback from one or more other users.

10. The article of claim 9, wherein encoding includes encoding feedback received from the one or more other users.

11. A system operating in a communication network, comprising:
a computer comprising a memory to store a program code, and a processor to execute the program code to:
receive, via a user interface, a first set of data from a user relating to a first task involving the user, at a first point in time, wherein the first set of data is composed of strings of characters, further wherein at least one of the first set of data is a selection of one or more goal types;
receive a second set of data from the user relating to a second task involving the user, at a second point in time, wherein the second set of data is composed of strings of characters;
encode the first set of data and the second set of data into graphical elements;
generate a multimedia presentation comprising the graphical elements; and
render the multimedia presentation in response to a request received at a third point in time.

12. The system of claim 11, wherein the first point in time and the second point in time belong to a performance cycle and the third point in time belongs to an assessment period.

13. The system of claim 1 wherein at least one of the first set of data is a request for feedback from one or more other users.

14. The system of claim 11, wherein the received self-assessment data includes a performance rating.

15. The system of claim 11, wherein the one or more goal types represent a performance attribute.

16. The system of claim 1 wherein the strings of characters are composed of a combination of alphabets, numerical digits, and punctuation marks.

17. The system of claim 11, wherein the graphical elements comprise one or more of an image, a visual cue, a histogram, a plot, a graph, and a chart.

18. The system of claim 11, wherein the multimedia presentation includes one or more of text, audio, still image, and animation.
